(19) United States
(12) Patent Application Publication
(10) Pub. No.: US 2026/0194336 A1
(43) Pub. Date: Jul. 9, 2026

(54) Gas Line Size Gauge Device

(71) Applicant: Eric Price, Jensen Beach, FL (US)

(72) Inventor: Eric Price, Jensen Beach, FL (US)

(21) Appl. No.: 19/177,777

(22) Filed: Apr. 14, 2025

Related U.S. Application Data
(60) Provisional application No. 63/743,368, filed on Jan. 9, 2025.

(51) Int. Cl. G01B 3/34; G01B 3/46

(52) U.S. Cl. CPC G01B 3/34; G01B 3/46

(57) ABSTRACT

A gas line size gauge device is provided. The device is designed to assist first responders, utility workers, and contractors in accurately identifying natural gas pipe sizes during field operations. The device comprises multiple pipe sections corresponding to common industry-standard diameters. A connecting member secures the sections while allowing individual sections to be rotated upwards or downwards for direct size comparison. Each section includes permanent markings, which may be embossed, laser-etched, or phosphorescent for enhanced visibility. Color differentiation between the sections may further aid in quick identification. The device also features attachment points for securing to tool belts or emergency kits. A method of using the device involves extending individual sections to compare with a gas pipe, repeating the process until a match is found, and referencing the corresponding marking for verification.

### CROSS-REFERENCE TO RELATED APPLICATION

The present application claims priority to, and the benefit of, U.S. Provisional Application No. 63/743,368, which was filed on Jan. 9, 2025, and is incorporated herein by reference in its entirety.

### FIELD OF THE INVENTION

The present invention relates generally to the field of piping. More specifically, the present invention relates to a device designed to assist first responders, utility workers, and contractors in accurately identifying natural gas pipe sizes during field operations. Accordingly, the present disclosure makes specific reference thereto. Nonetheless, it is to be appreciated that aspects of the present invention are also equally applicable to other like applications, devices, and methods of manufacture.

### BACKGROUND

Identifying the size of a natural gas pipe can be challenging, even for experienced professionals. During emergencies, such as gas leaks or pipeline damage, quickly determining the correct pipe size is critical to ensuring that proper repairs are made. Miscommunication or incorrect size identification can result in the use of improperly sized equipment, delaying response efforts and increasing safety risks. First responders, utility workers, and contractors must often rely on visual estimations or outdated measurement tools, which may lead to errors. These errors can cause inefficiencies, unnecessary delays, and potential hazards in high-pressure situations where immediate action is required. Existing solutions for measuring pipe diameters are often cumbersome, time-consuming, or not designed for emergency use. The lack of a reliable and portable tool for accurate gas pipe size identification presents a significant challenge in field operations. As a result, there is a strong need for a dedicated device that enables quick, precise, and easy identification of natural gas pipe sizes to improve response efficiency and safety.

Therefore, there exists a long-felt need in the art for a gas line size gauge device that provides first responders, utility workers, and contractors with a reliable means of accurately identifying the diameter of natural gas pipes. There also exists a long-felt need in the art for a gas line size gauge device that reduces the risk of miscommunication and delays during emergency response situations by enabling quick visual and physical comparison of pipe sizes. Moreover, there exists a long-felt need in the art for a gas line size gauge device that is compact, portable, and durable, allowing for easy storage and accessibility in emergency response kits and utility tool bags.

The subject matter disclosed and claimed herein, in one embodiment thereof, comprises a gas line size gauge device. The device is designed to assist first responders, utility workers, and contractors in accurately identifying natural gas pipe sizes during field operations. The device comprises multiple pipe sections corresponding to common industry-standard diameters. A connecting member secures the sections while allowing individual sections to be rotated upward or downward for direct size comparison. Each section includes permanent markings, which may be embossed, laser-etched, or phosphorescent for enhanced visibility. Color differentiation between the sections may further aid in quick identification. The device also features attachment points for securing to tool belts or emergency kits. A method of using the device involves extending individual sections to compare with a gas pipe, repeating the process until a match is found, and referencing the corresponding marking for verification. The compact, lightweight design ensures ease of storage and efficient, reliable operation in diverse field conditions.

In this manner, the gas line size gauge device of the present invention accomplishes all the foregoing objectives and provides a compact and portable tool specifically designed to assist in the identification of natural gas pipe sizes. More specifically, the multiple pipe sections corresponding to common industry-standard diameters allow for quick and accurate size comparison. The sliding mechanism further ensures that only one section is extended at a time, preventing confusion and enabling a clear measurement. The visible and permanent size markings further improve readability even in low-light environments. Additionally, the inclusion of a fastening accessory enables easy attachment to a utility belt or emergency response kit, ensuring quick access when needed. By integrating these features, the gas line size gauge device provides an effective solution for fast and precise gas pipe size identification, improving efficiency and safety in the field.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gas line size gauge device. The gas line size gauge device is a portable tool designed to assist first responders, utility workers, and contractors in identifying natural gas pipe sizes during field operations. The device is comprised of multiple pipe sections, each corresponding to a standard industry pipe diameter.

In the preferred embodiment, the device includes seven pipe sections with diameters ranging from ½ inch to 2 inches in ¼ inch increments. Each pipe section features at least one opening, allowing the sections to be positioned side by side. A rigid connecting member runs through the openings, securing the sections while permitting individual sections to be rotated upward or downward. This sliding mechanism allows a single pipe section to extend upwards or downwards for direct comparison with an existing gas pipe, ensuring an unobstructed view of the measurement.

Each pipe section is marked with the diameter of the section, using embossed or laser-etched numerical characters for visibility and resistance to wear. Some embodiments incorporate color-coded sections corresponding to industry size classifications for quick identification. Additionally, phosphorescent markings may be used for improved visibility in low-light conditions, and contrasting colors may enhance legibility. One or more pipe sections may include an opening for attaching a carabiner or similar fastening accessory, allowing the device to be secured to a utility belt, tool bag, or emergency response kit for easy access.

A method of using the device involves positioning the device near a gas pipe, sliding out a pipe section for comparison, and adjusting until a matching diameter is found. The corresponding marking is then referenced for verification before returning the pipe section to its original position.

Accordingly, the gas line size gauge device of the present invention is particularly advantageous as it provides a compact and portable tool specifically designed to assist in the identification of natural gas pipe sizes. More specifically, the multiple pipe sections corresponding to common industry-standard diameters allow for quick and accurate size comparison. The sliding mechanism further ensures that only one section is extended at a time, preventing confusion and enabling a clear measurement. The visible and permanent size markings further improve readability even in low-light environments. Additionally, the inclusion of a fastening accessory enables easy attachment to a utility belt or emergency response kit, ensuring quick access when needed. By integrating these features, the gas line size gauge device provides an effective solution for fast and precise gas pipe size identification, improving efficiency and safety in the field.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a gas line size gauge device of the present invention in accordance with the disclosed architecture;

FIG. 2 illustrates a side perspective view of one potential embodiment of a gas line size gauge device of the present invention in accordance with the disclosed architecture;

FIG. 3 illustrates a front view of one potential embodiment of a gas line size gauge device of the present invention with a pipe section rotated downwards in accordance with the disclosed architecture; and

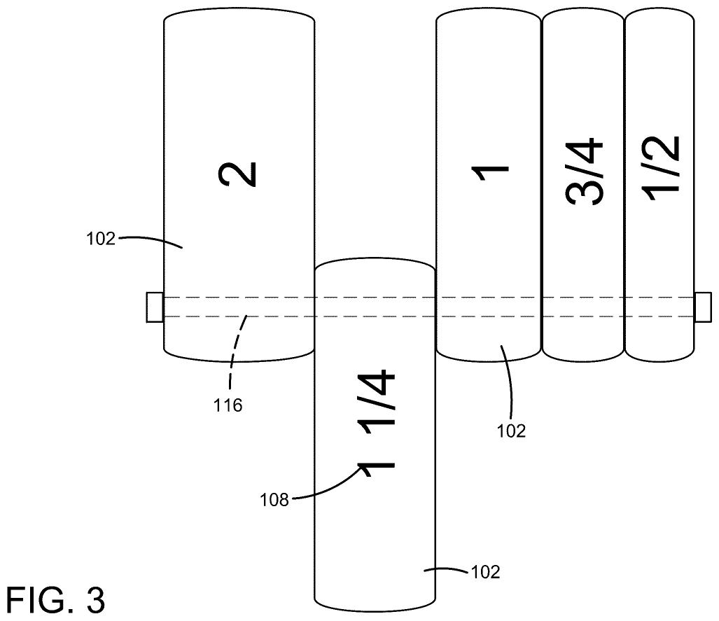

FIG. 4 illustrates a flowchart of a method of using one potential embodiment of a gas line size gauge device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a gas line size gauge device that provides first responders, utility workers, and contractors with a reliable means of accurately identifying the diameter of natural gas pipes. There also exists a long-felt need in the art for a gas line size gauge device that reduces the risk of miscommunication and delays during emergency response situations by enabling quick visual and physical comparison of pipe sizes. Moreover, there exists a long-felt need in the art for a gas line size gauge device that is compact, portable, and durable, allowing for easy storage and accessibility in emergency response kits and utility tool bags.

The present invention, in one exemplary embodiment, is comprised of a gas line size gauge device. The gas line size gauge device is a portable tool designed to help first responders, utility workers, and contractors determine natural gas pipe sizes during field operations. The device is comprised of multiple pipe sections, each corresponding to a standard industry pipe diameter.

In the preferred embodiment, the device includes seven pipe sections with diameters ranging from ½ inch to 2 inches in ¼-inch increments. Each pipe section has at least one opening running along its length, allowing the sections to be positioned side by side. A rigid connecting member extends through these openings, securing the sections while enabling individual sections to be rotated upward or downward. This sliding mechanism allows a single pipe section to extend upwards or downwards for direct comparison with an existing gas pipe, ensuring a clear and unobstructed view of the measurement.

Each pipe section is marked with a respective diameter, using embossed or laser-etched numerical characters for durability and visibility. Some embodiments feature color-coded sections corresponding to industry size classifications for quick identification. Phosphorescent markings may be included to enhance visibility in low-light conditions, and contrasting colors can further improve legibility. One or more pipe sections may incorporate an opening for attaching a carabiner or similar fastening accessory, allowing secure attachment to a utility belt, tool bag, or emergency response kit for easy access.

The method of use involves positioning the device near a gas pipe, sliding out a pipe section for comparison, and continuing the process until a matching diameter is identified. The corresponding marking is then referenced for verification before returning the pipe section to its original position.

The gas line size gauge device offers a compact and portable solution for identifying gas pipe sizes efficiently. The inclusion of multiple pipe sections corresponding to industry-standard diameters allows for quick and accurate size comparison. The sliding mechanism ensures that only one section is extended at a time, preventing confusion and enabling a precise measurement. The clearly visible, permanent size markings improve readability, even in low-light environments. Additionally, the fastening accessory allows for convenient attachment to a utility belt or emergency kit, ensuring quick access when needed. These features collectively enhance efficiency and safety in field operations.

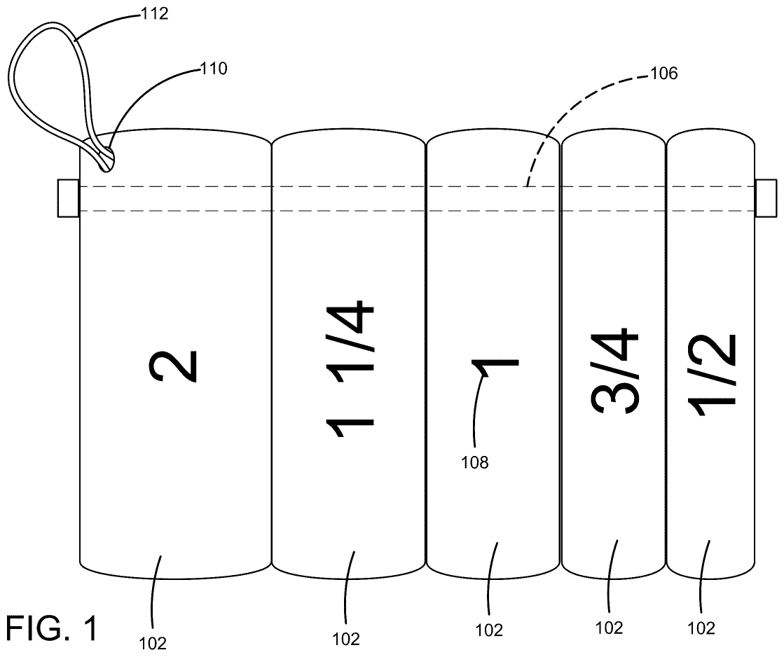

Referring initially to the drawings, FIG. 1 illustrates a front view of one potential embodiment of a gas line size gauge device 100 of the present invention in accordance with the disclosed architecture. The gas line size gauge device 100 is a compact, portable tool configured to assist first responders, utility workers, and contractors in accurately identifying the size of natural gas pipes during field operations. The gas line size gauge device 100 is comprised of a plurality of pipe sections 102, each corresponding to a common industry-standard pipe diameter.

In the preferred embodiment, the gas line size gauge device 100 is comprised of seven pipe sections 102 with diameters of ½ inch, ¾ inch, 1 inch, 1¼ inch, 1½ inch, 1¾ inch, and 2 inches. However, in various embodiments, the diameters of the pipe sections 102 may vary, and additional sections may be included to accommodate alternative pipe sizing standards. Each pipe section 102 is preferably comprised of a UV-resistant, impact-resistant polymer to ensure durability and reliability in outdoor and emergency conditions. Alternative embodiments may incorporate materials such as reinforced composites or lightweight metals to enhance structural integrity while maintaining portability. In one embodiment, each section 102 may be telescopic to allow for easy storage/transport of the device.

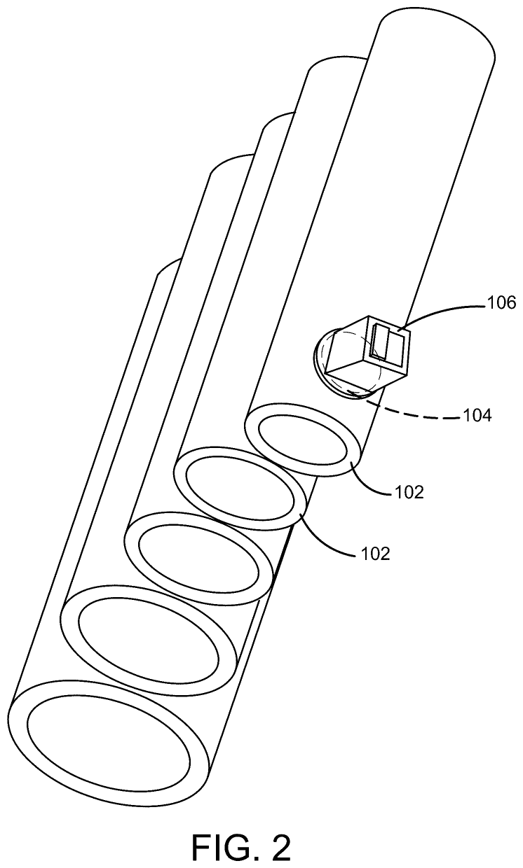

Each pipe section 102 includes at least one opening 104, (as seen in FIG. 2) allowing multiple pipe sections 102 to be positioned in a side-by-side configuration. A rigid connecting member 106 extends through the openings 104 of all pipe sections 102, securing the pipe sections 102 together. The connecting member 106 is configured to allow each individual pipe section 102 to be rotated upward or downward (as seen in FIG. 2), enabling the selected pipe section 102 to extend upwards or downwards from the remaining sections for direct size comparison with an existing gas pipe. The sliding mechanism is designed to ensure that only one pipe section 102 is extended at a time, providing a clear and unobstructed view of the measurement without interference from adjacent pipe sections 102. In one embodiment, the connecting member 106 is comprised of a corrosion-resistant metal rod or a reinforced polymer bar to maintain structural integrity under repeated use.

Each pipe section 102 is comprised of at least one marking 108 that indicates the diameter of the respective pipe section 102. The markings 108 may be in the form of embossed, raised numerical characters to ensure permanent visibility even if the surface becomes worn or scratched. In an alternative embodiment, the markings 108 may be laser-etched into each pipe section 102 to provide additional precision and long-term resistance to fading.

To further enhance visual distinction, each pipe section 102 may be a different color from the other pipe sections 102, with the color corresponding to specific industry size classifications and coding standards. This variation allows for rapid identification of sizes without reliance solely on numerical markings 108. In one embodiment, the markings 108 are phosphorescent, enabling them to glow in the dark to improve visibility in low-light environments such as underground utility spaces, nighttime emergency situations, or dimly lit job sites. In a further embodiment, the markings 108 may contrast in color with the color of each section 102.

In one embodiment, at least one of the pipe sections 102 includes at least one opening 110 configured to accommodate the attachment of a carabiner, loop, or similar fastening accessory 112, as seen in FIG. 1. The fastening accessory 112 enables the gas line size gauge device 100 to be secured to a utility belt, tool bag, or emergency response kit, ensuring convenient access in field environments.

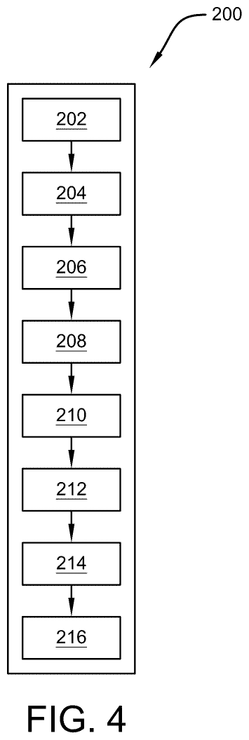

The present invention is also comprised of a method of using 200 the gas line size gauge device 100, as seen in FIG. 4. First, a gas line size gauge device 100 is provided, the gas line size gauge device 100 being comprised of a plurality of pipe sections 102, at least one opening 104, a connecting member 106, and at least one marking 108 [Step 202]. Then, the gas line size gauge device 100 is positioned near a gas pipe requiring size identification [Step 204]. Next, one of the pipe sections 102 is rotated upwards or downwards along the connecting member 106 to extend from the remaining pipe sections 102 [Step 206]. The extended pipe section 102 is then aligned with the gas pipe to compare the diameter of the pipe section 102 to the diameter of the gas pipe [Step 208]. If the extended pipe section 102 does not match the diameter of the gas pipe, the pipe section 102 is rotated back into the side-by-side configuration, and a different pipe section 102 is extended for comparison [Step 210]. This process is repeated until a pipe section 102 with a matching diameter is identified [Step 212]. Once a matching pipe section 102 is determined, the corresponding marking 108 on the pipe section 102 is referenced to verify the gas pipe size [Step 214]. Finally, after the gas pipe size has been identified, the extended pipe section 102 is rotated back into its original position [Step 216].

As a result, the gas line size gauge device 100 is compact and lightweight, facilitating easy storage in utility belts or emergency response kits. The design is fully compatible with the most commonly used gas pipe sizes in residential and commercial installations. The combination of the sliding mechanism and multiple size identification methods ensures a highly efficient and user-friendly solution for fast and accurate pipe size determination in field applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gas line size gauge device” and “device” are interchangeable and refer to the gas line size gauge device 100 of the present invention.

Notwithstanding the foregoing, the gas line size gauge device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the gas line size gauge device 100 as shown in the FIGS. are for illustrative purposes only, and that many other sizes and shapes of the gas line size gauge device 100 are well within the scope of the present disclosure. Although the dimensions of the gas line size gauge device 100 are important design parameters for user convenience, the gas line size gauge device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising,” as “comprising” is interpreted when employed as a transitional word in a claim.

What is claimed is:

1. A gas line size gauge device comprising:
a first pipe section of a first diameter, the first pipe section comprised of a first opening and a first marking;
a second pipe section of a second diameter, the second pipe section comprised of a second opening and a second marking; and
a connecting member extending through the first opening and the second opening, wherein the second member secures the first pipe section to the second section pipe.

2. The gas line size gauge device of claim 1, wherein the first marking and the second marking are comprised of embossed markings.

3. The gas line size gauge device of claim 1, wherein the first marking and the second marking are comprised of laser-etched markings.

4. The gas line size gauge device of claim 1, wherein the first pipe section is comprised of a first color and the second pipe section is comprised of a second color.

5. The gas line size gauge device of claim 1, wherein the first marking and the second marking are comprised of phosphorescent markings.

6. The gas line size gauge device of claim 1, wherein the first pipe section is comprised of an opening.

7. The gas line size gauge device of claim 6 further comprised of a carabiner or a loop positioned through the opening.

8. The gas line size gauge device of claim 4, wherein the first marking is comprised of a third color that contrasts with the first color.

9. The gas line size gauge device of claim 4, wherein the first marking is comprised of a fourth color that contrasts with the second color.

10. A gas line size gauge device comprising:
a first pipe section of a first diameter, the first pipe section comprised of a first opening and a first marking;
a second pipe section of a second diameter, the second pipe section comprised of a second opening and a second marking; and
a connecting member extending through the first opening and the second opening, wherein the second member secures the first pipe section to the second section pipe;
wherein the connecting member allows the first pipe section to be rotated relative to the second pipe section and allows the first pipe section to extend upwards or downwards from the second pipe section; and
wherein the connecting member allows the second pipe section to be rotated relative to the first pipe section and allows the second pipe section to extend upwards or downwards from the first pipe section.

11. The gas line size gauge device of claim 10, wherein the first marking and the second marking are comprised of embossed markings.

12. The gas line size gauge device of claim 10, wherein the first marking and the second marking are comprised of laser-etched markings.

13. The gas line size gauge device of claim 10, wherein the first pipe section is comprised of a first color and the second pipe section is comprised of a second color.

14. The gas line size gauge device of claim 10, wherein the first marking and the second marking are comprised of phosphorescent markings.

15. The gas line size gauge device of claim 10, wherein the first pipe section is comprised of an opening.

16. The gas line size gauge device of claim 15 further comprised of a carabiner or a loop positioned through the opening.

17. The gas line size gauge device of claim 13, wherein the first marking is comprised of a third color that contrasts with the first color.

18. The gas line size gauge device of claim 13, wherein the first marking is comprised of a fourth color that contrasts with the second color.

19. A method of using a gas line size gauge device, the method comprising the following steps:
providing a gas line size gauge device comprised of a first pipe section comprised of a first opening and a first marking, a second pipe section comprised of a second opening and a second marking, and a connecting member that is positioned through the first opening and the second opening and that connects the first pipe section to the second pipe section;
positioning the gas line size gauge device near a gas pipe requiring size identification;
rotating the first pipe section upwards or downwards along the connecting member to extend from the second pipe section;
aligning the first pipe section with the gas pipe to compare a first diameter of the pipe section to a second diameter of the gas pipe; and
referencing the first marking to verify the second diameter of the gas pipe.

20. The method of using a gas line size gauge device of claim 19 further comprised of a step of sliding the first pipe section upwards or downwards such that the first pipe section is once again adjacent to the second pipe section.
